(19) United States
(12) Patent Application Publication
(10) Pub. No.: US 2008/0135404 A1
(43) Pub. Date: Jun. 12, 2008

(54) Redox-Active Species Sensor and Method of Use Thereof

(76) Inventors: Robert D. Rowe, Victoria (CA); Thomas M. Fyles, Victoria (CA)

Correspondence Address: KLARQUIST SPARKMAN, LLP, 121 S.W. SALMON STREET, SUITE 1600, PORTLAND, OR, 97204, US

(21) Appl. No.: 11/795,275

(22) PCT Filed: Jan. 10, 2006
(86) PCT No.: PCT/CA06/00024

§ 371 Date: Jul. 12, 2007

Related U.S. Application Data
(60) Provisional application No. 60/644,081, filed on Jan. 14, 2005.

(51) Int. Cl. G01N 27/40

(52) U.S. Cl. 204/295

(57) ABSTRACT

An amperometric membrane sensor that utilizes redox-carriers to transfer the redox potential of an oxidizing or reducing species to an electrode. The sensor consists of a membrane containing a first redox carrier, and a second redox carrier in the internal electrolyte of a membrane amperometric sensor. One implementation of this sensor utilizes a quinone carrier in a liquid membrane, and a vanadate carrier in the electrolyte to produce a sensor that responds to chlorine and chloroamine containing aqueous solutions. This strategy for the construction of an amperometric sensor allows the detection and quantification of redox-active membrane impermeant species.

### CROSS REFERENCE TO RELATED APPLICATION

This claims the benefit of the earlier filing date of U.S. Provisional Application No. 60/644,081, filed Jan. 14, 2005, which is incorporated herein by reference.

### FIELD

The present disclosure relates to a redox-carrier membrane system for detecting and quantifying redox-active membrane-impermeant species by means of an amperometric membrane sensor based on the redox-carrier membrane system. Additionally, a method of detecting and quantifying redox-active impermeant species is provided.

### BACKGROUND

Amperometric membrane sensors are well known. For example, a Clark cell can be used to detect dissolved oxygen or other oxidizing small molecules [see, for example, Janata, J., Principles of Chemical Sensors, Plenum Publishing, 1991 and Polarographic Oxygen Sensors, Chapter 4, Gnaiger, E. and Forstner, H. (Eds.), Springer-Verlag, 1983]. Such sensors consist of a membrane, an internal electrolyte and an electrode. The species detected diffuses through the membrane and the internal electrolyte and is reduced or oxidized at the electrode to generate a current that is proportional to the concentration of the species in the external solution. The specificity of these sensors is determined by the selectivity of the diffusion through the membrane layer. In an oxygen electrode, the oxygen molecule can diffuse to the electrode to generate the current due to reduction at the electrode. At the same time, ionic species are repelled by the membrane and therefore cannot contribute to the current generated.

Chlorine sensors are known to operate on the same principle [Janata, op cit.]. In these sensors, the membrane must allow the free diffusion of chlorine. Since chlorine in water forms an equilibrium mixture of dissolved chlorine and hypochlorous acid, some chlorine sensors also detect the hypochlorous acid that diffuses through the membrane. Hypochlorous acid is a weak acid (pKa=7.49; Pourbaix, Atlas of Electrochemical Equilibria in Aqueous Solutions, Section 20.2, Pergamon Press, 1966) and therefore the concentration of this species depends on the pH. The conjugate base, hypochlorite anion, is ionic and is therefore repelled by the membrane of conventional chlorine sensors. The result is that conventional amperometric chlorine sensors do not function in basic solution. In fact, the sensitivity of the sensors falls off rapidly as the pH increases above pH 7. Such amperometric chlorine sensors are also insensitive to other chlorine species. For example, in a mixture of chlorine and ammonia, mono-, di-, and tri-chloroamines are formed [Soulard, M.; Bloc, F. Hatterer J. Chem. soc. Dalton 1981, 2300-2310]. These species are similarly repelled by the membrane of a conventional chlorine sensor and do not produce a signal.

Chlorination and chloramination of domestic drinking water supplies is widely practiced as part of a disinfection process to produce potable water [Alternative Disinfectants and Oxidants Guidance Manual, United States Environmental Protection Agency, 1999, EPA 815-R-99-014]. Determination of the levels of chloroamines in disinfection processes is currently done using colorimetric or titrimetric methods because the currently available chlorine sensors do not detect chloroamines. This is tedious and cannot be done in a continuous fashion.

Amperometric biosensors have also been developed for the measurement of biological species such as glucose. These so-called biosensors have immobilized enzyme membranes. Some of the drawbacks of the current amperometric biosensors have been noted and analyzed. For example, direct electron transfer between enzymes and electrode surfaces is rarely encountered because the active site of redox enzymes is generally buried within the body of the protein. Hence, electron transfer is usually performed according to a ‘shuttle’ mechanism involving free-diffusing electron-transferring redox species. These redox mediators must diffuse freely between the active sites of the enzymes and the electrode surface through a predominantly aqueous layer as required for the stability and reactivity of the enzyme. Hence, these electrodes show a limited long-term stability as a consequence of the unavoidable leaking of the mediator from the sensor surface.

These amperometric enzyme electrodes are very different from amperometric membrane sensors of the type we describe, with the exception that they also use redox relays. The rationale for these biosensors is to use enzymatic specificity based on specific molecular recognition of a biological substrate. On a fundamental level, therefore, these enzyme electrodes require enzymatic catalysis in order to function. Of course, the sensors must also be robust. Clearly, naturally occurring enzymes are not robust enough to have utility in sensors, as their functionality depends entirely upon their three dimensional structure and this is dependent upon factors including temperature, pH and salt concentration.

In a related application, redox relay membranes have been described as biomimetic models of reaction coupling between two aqueous compartments [Anderson, S. S.; Lyle, I. G.; Petrson, R. Nature, 1976, 259, 147-148; Grimaldi, J. J.; Bioleau, S.; Lehn, J.-M. Nature 1977, 265, 229-230]. As the name suggests, the redox relays mimic redox relays that are known to occur in biological systems, such as electron transfer during respiration. In both the natural system and the biomimetic models, the electron transfer is actually a cascade, with a drop of energy occurring along the relay. Accordingly, the systems have to be set up in such as fashion that they drive the process toward the product. An electron acceptor terminates the systems. In the biomimetic models electron transfer is detected using the UV spectrum of the ferri-ferrocyanide pair. Neither paper describes what happens as the driving force falls off, but presumably, the reduction of the product ceases and hence a constant level of product is maintained. In sensors, it is the drop in driving force that is measured. Hence, while these redox relay models are useful for studying biological electron transfer systems, they lack utility as sensors for redox-active species.

### SUMMARY

A redox relay membrane system for use with an electrode to transfer a redox potential from a redox-active species to an electrode by redox reactions is provided in one embodiment of the invention. The redox relay membrane system comprises:

a redox relay membrane comprises a first redox carrier and a membrane, the membrane being impermeant to redox-active species; and

an internal electrolyte solution comprises an electrolyte and a second redox carrier.

In another aspect of the redox relay membrane system the first redox carrier is selected from the group consisting of

quinone and hydroquinones including benzo-, naphtho, and anthro-quinones,

thiols and disulfides,

flavins,

metal complexes of porphyrins,

metal complexes of phthalocyanins,

ferrocene and other neutral transition complexes of cyclopentadiene derivatives, and metal complexes of dithiolenes.

In another aspect of the redox relay membrane system the first redox carrier comprises a quinone.

In another aspect of the redox relay membrane system the second redox carrier comprises an inorganic species, the inorganic species characterized as being oxidized or reduced by the first redox carrier and being oxidized or reduced by an electrode.

In another aspect of the redox relay membrane system the second redox carrier is selected from the group consisting of

transition metal cations including, chromium (3+), manganese (2+), iron (2+ and 3+), cobalt (2+ and 3+), nickel (2+), copper (2+), or zinc (2+); oxo, hydroxo, chloro, bromo, amine, azido, thiocyanato, and

cyano complex ions of vanadium, chromium, molybdenum, manganese, rhenium, iron, ruthenium, osmium, cobalt, rhodium, iridium, nickel, palladium, platinum, copper, silver, gold and

oxyanions of sulfur, arsenic, antimony, chlorine, and bromine.

In another aspect of the redox relay membrane system the second redox carrier is ferrocyanide anion or trivalent vanadium oxyanion.

In another aspect of the redox relay membrane system the membrane comprises a supported liquid membrane.

In another aspect of the redox relay membrane system the supported liquid membrane comprises a porous support polymer comprises a solvent.

In another aspect of the redox relay membrane system the porous support polymer comprises a microporous polycarbonate membrane and the solvent is selected from the group consisting of o-nitrophenyl octyl ether, dioctyl adipate, adipate esters, sebacate esters, phthalate esters, glycol esters, low volatility ethers, low volatility aromatic and aliphatic hydrocarbons, trimellitic acid esters, phosphate triesters, chlorinated paraffins and mixtures thereof.

In another aspect of the redox relay membrane system the supported liquid membrane comprises a plasticized polymer.

In another aspect of the redox relay membrane system the plasticized polymer comprises poly(vinyl chloride).

In another aspect of the redox relay membrane system the plasticized polymer comprises a high molecular weight poly(vinyl chloride) plasticized with a solvent selected from the group consisting of o-nitrophenyl octyl ether, dioctyl adipate, adipate esters, sebacate esters, phthalate esters, glycol esters, low volatility ethers, trimellitic acid esters, phosphate triesters, chlorinated paraffins, and mixtures thereof.

In another aspect of the redox relay membrane system the electrolyte comprises a Group I metal halide, nitrate, or perchlorate.

In another aspect of the redox relay membrane system the Group I metal halide, nitrate, or perchlorate comprise KCl, NaCl, KNO₃, NaNO₃, KClO₄, NaClO₄ or a mixture thereof.

In another aspect of the redox relay membrane system the membrane comprises from 0.1% to 10% by weight of a guanidinium salt.

In another aspect of the redox relay membrane system the guanidinium salt comprises 1% to 5% by weight of the membrane.

In another aspect of the redox relay membrane system the guanidinium salt has the formula:

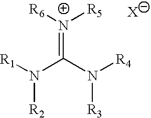

wherein R1, R2, R3, R4, R5 and R6 are independently selected from the group consisting of substituted alkyl, cycloalkyl, substituted cycloalkyl, alkenyl, substituted alkenyl, cycloalkenyl, substituted cycloalkenyl, alkynyl, substituted aryl, heteroaryl and substituted heteroaryl such that the salt has an affinity for the membrane and X— is an anion.

In another aspect of the redox relay membrane system X— is selected from the group consisting of chloride, bromide, fluoride, iodide, hydroxide, acetate, carbonate, sulfate and nitrate and combinations thereof.

In another aspect of the redox relay membrane system R1, R2, R3, R4, R5 and R6 are independently selected from the group consisting of hydrogen, C1-30 alkyl, and aryl.

In another aspect of the redox relay membrane system the guanidinium salt is not covalently bonded to the membrane.

In another aspect of the redox relay membrane system the first redox carrier and the second redox carrier are selected such that the first redox carrier is oxidized and the second redox carrier is oxidized to permit measurement of an oxidizing species.

In another aspect of the redox relay membrane system the first redox carrier and the second redox carrier are selected such that the first redox carrier is reduced and the second redox carrier is reduced to permit measurement of a reducing species.

In another embodiment of the invention, an amperometric sensor combination is provided that comprises:

a redox relay membrane comprises a first redox carrier and a membrane, the membrane being impermeant to redox-active species;

an internal electrolyte solution comprises an electrolyte and a second redox carrier; and

an electrode.

In another aspect of the combination the electrode comprises:

an inert cathode; and

a reversible anode.

In another aspect of the combination the inert cathode is selected from the group consisting of silver, palladium, iridium, rhodium, ruthenium, and osmium and alloys thereof and the reversible anode is selected from the group consisting of lead/lead sulfate, silver/silver oxide-hydroxide, silver/silver chloride and lead/lead oxide-hydroxide.

In another aspect of the combination the inert cathode is selected from the group consisting of silver, palladium, and iridium, and alloys thereof and the reversible anode is selected from the group consisting of lead/lead sulfate, silver/silver oxide-hydroxide, silver/silver chloride and lead/lead oxide-hydroxide.

In another aspect of the combination the inert cathode comprises gold or platinum and the reversible anode is an Ag/AgCl electrode.

In another aspect of the combination the first redox carrier is selected from the group consisting of

quinone and hydroquinones including benzo-, naphtho, and anthro-quinones,

thiols and disulfides,

flavins,

metal complexes of porphyrins,

metal complexes of phthalocyanins,

ferrocene and other neutral transition complexes of cyclopentadiene derivatives, and metal complexes of dithiolenes.

In another aspect of the combination the first redox carrier comprises a quinone.

In another aspect of the combination the second redox carrier comprises an inorganic species, the inorganic species characterized as being oxidized or reduced by the first redox carrier and being oxidized or reduced by the electrode.

In another aspect of the combination the second redox carrier is selected from the group consisting of

transition metal cations including, chromium (3+), manganese (2+), iron (2+ and 3+), cobalt (2+ and 3+), nickel (2+), copper (2+), or zinc (2+); oxo, hydroxo, chloro, bromo, amine, azido, thiocyanato, and

cyano complex ions of vanadium, chromium, molybdenum, manganese, rhenium, iron, ruthenium, osmium, cobalt, rhodium, iridium, nickel, palladium, platinum, copper, silver, gold and

oxyanions of sulfur, arsenic, antimony, chlorine, and bromine.

In another aspect of the combination the second redox carrier is ferrocyanide or trivalent vanadium oxyanion.

In another aspect of the combination the membrane comprises a supported liquid membrane.

In another aspect of the combination the supported liquid membrane comprises a porous support polymer comprises a solvent.

In another aspect of the combination the porous support polymer comprises a microporous polycarbonate membrane and the solvent is selected from the group consisting of o-nitrophenyl octyl ether, dioctyl adipate, adipate esters, sebacate esters, phthalate esters, glycol esters, low volatility ethers, low volatility aromatic and aliphatic hydrocarbons, trimellitic acid esters, phosphate triesters, chlorinated paraffins, and mixtures thereof.

In another aspect of the combination the supported liquid membrane comprises a plasticized polymer.

In another aspect of the combination the plasticized polymer comprises poly(vinyl chloride).

In another aspect of the combination the plasticized polymer comprises a high molecular weight poly(vinyl chloride) plasticized with a solvent selected from the group consisting of o-nitrophenyl octyl ether, dioctyl adipate, adipate esters, sebacate esters, phthalate esters, glycol esters, low volatility ethers, trimellitic acid esters, phosphate triesters, chlorinated paraffins, and mixtures thereof.

In another aspect of the combination the electrolyte comprises a Group I metal halide, nitrate, or perchlorate.

In another aspect of the combination the Group I metal halide, nitrate, or perchlorate comprise KCl, NaCl, KNO₃, NaNO₃, KClO₄, NaClO₄ or a mixture thereof.

In another aspect of the combination the membrane comprises from 0.1% to 10% by weight of a guanidinium salt.

In another aspect of the combination the guanidinium salt comprises 1% to 5% by weight of the membrane.

In another aspect of the combination the guanidinium salt has the formula:

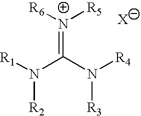

wherein R1, R2, R3, R4, R5 and R6 are independently selected from the group consisting of substituted alkyl, cycloalkyl, substituted cycloalkyl, alkenyl, substituted alkenyl, cycloalkenyl, substituted cycloalkenyl, alkynyl, substituted aryl, heteroaryl and substituted heteroaryl such that the salt has an affinity for the membrane and X— is an anion.

In another aspect of the combination X— is selected from the group consisting of chloride, bromide, fluoride, iodide, hydroxide, acetate, carbonate, sulfate and nitrate and combinations thereof.

In another aspect of the combination R1, R2, R3, R4, R5 and R6 are independently selected from the group consisting of hydrogen, C1-30 alkyl, and aryl.

In another aspect of the combination the guanidinium salt is not covalently bonded to the membrane.

In another aspect the combination is formed on a printed circuit board, wherein the membrane is sealed at its outer edges to prevent communication between the electrolyte and a medium in which the redox-active species is sensed except through the membrane.

In another aspect of the combination the first redox carrier and the second redox carrier are selected such that the first redox carrier is oxidized and the second redox carrier is oxidized to permit measurement of an oxidizing species.

In another aspect of the combination the first redox carrier and the second redox carrier are selected such that the first redox carrier is reduced and the second redox carrier is reduced to permit measurement of a reducing species.

In another embodiment of the invention an amperometric sensor combination is provided that comprises:

an inert cathode and a reversible anode printed on a gas-impervious circuit board substrate;

a well surrounding the cathode and the anode;

a redox relay membrane covering the well, the redox-relay membrane comprises a first redox carrier and a membrane, the membrane being impermeant to redox-active species; and

a hydrogel in the well, wherein the hydrogel comprises an electrolyte and a second redox carrier.

In another aspect of the combination the first redox carrier is selected from the group consisting of

quinone and hydroquinones including benzo-, naphtho, and anthro-quinones,

thiols and disulfides,

flavins,

metal complexes of porphyrins,

metal complexes of phthalocyanins,

ferrocene and other neutral transition complexes of cyclopentadiene derivatives, and metal complexes of dithiolenes.

In another aspect of the combination the first redox carrier comprises a quinone.

In another aspect of the combination the second redox carrier comprises an inorganic species, the inorganic species characterized as being oxidized or reduced by the first redox carrier and being oxidized or reduced by the electrode.

In another aspect of the combination the second redox carrier is selected from the group consisting of

transition metal cations including, chromium (3+), manganese (2+), iron (2+ and 3+), cobalt (2+ and 3+), nickel (2+), copper (2+), or zinc (2+); oxo, hydroxo, chloro, bromo, amine, azido, thiocyanato, and

cyano complex ions of vanadium, chromium, molybdenum, manganese, rhenium, iron, ruthenium, osmium, cobalt, rhodium, iridium, nickel, palladium, platinum, copper, silver, gold and

oxyanions of sulfur, arsenic, antimony, chlorine, and bromine.

In another aspect of the combination the second redox carrier is ferrocyanide or trivalent vanadium.

In another aspect of the combination the well defining the electrolyte volume comprises a laminate material having a hole, wherein the hole is placed over the anode and the cathode.

In another aspect the combination further comprises a guard ring deposited on the gas-impervious substrate, wherein the redox-active species impermeant membrane also covers the guard ring.

In another aspect of the combination the hydrogel is selected from the group consisting of cross-linked acrylates, methyl methacrylates, methacrylates, hydryxalkyl acrylates, hydroxyalkyl(meth)acrylates, acrylamides, silicone hydrogels, gelatin, cellulose nitrate, cellulose, agar, and agarose and combinations thereof.

In yet another embodiment of the invention, a method of preparing an amperometric sensor comprises:

impregnating a redox impermeant membrane with a first redox carrier to produce a redox relay membrane;

dissolving an electrolyte and a second redox carrier in a solvent to prepare an internal electrolyte solution; and

placing the internal electrolyte solution on an electrode and covering the internal electrolyte solution with the redox-relay membrane.

In another aspect of the method, the electrode comprises:

an inert cathode; and

a reversible anode.

In another aspect the method further comprises selecting the inert cathode from the group consisting of silver, palladium, iridium, rhodium, ruthenium, and osmium and alloys thereof and the reversible anode is selected from the group consisting of lead/lead sulfate, silver/silver oxide-hydroxide, silver/silver chloride and lead/lead oxide-hydroxide.

In another aspect of the method, the inert cathode is selected from the group consisting of silver, palladium, and iridium, and alloys thereof and the reversible anode is selected from the group consisting of lead/lead sulfate, silver/silver oxide-hydroxide, silver/silver chloride and lead/lead oxide-hydroxide.

In another aspect the method further comprises selecting gold or platinum for the inert cathode and employing a reversible anode that is an Ag/AgCl electrode.

In another aspect the method further comprises selecting the first redox carrier from the group consisting of

quinone and hydroquinones including benzo-, naphtho, and anthro-quinones,

thiols and disulfides,

flavins,

metal complexes of porphyrins,

metal complexes of phthalocyanins,

ferrocene and other neutral transition complexes of cyclopentadiene derivatives, and metal complexes of dithiolenes.

In another aspect of the method, the second redox carrier comprises an inorganic species, the inorganic species characterized as being oxidized or reduced by the first redox carrier and being oxidized or reduced by the electrode.

In another aspect, the method further comprises selecting the second redox from the group consisting of

transition metal cations including chromium (3+), manganese (2+), iron (2+ and 3+), cobalt (2+ and 3+), nickel (2+), copper (2+), or zinc (2+),

oxo, hydroxo, chloro, bromo, amine, azido, thiocyanato, and cyano complex ions of vanadium, chromium, molybdenum, manganese, rhenium, iron, ruthenium, osmium, cobalt, rhodium, iridium, nickel, palladium, platinum, copper, silver, gold and

oxyanions of sulfur, arsenic, antimony, chlorine, bromine.

In another aspect, the method further comprises depositing the amperometric sensor on a printed circuit board, and sealing the membrane is sealed at its outer edges to prevent communication between the electrolyte and a medium in which the redox-active species is sensed except through the membrane.

In another aspect of the method, depositing comprises printing the anode and cathode onto the substrate using a method for printing circuit boards.

In another aspect the method further comprises depositing a guard ring onto the substrate.

In another aspect the method further comprises forming a well around the anode and the cathode and covering the well with the membrane to define an electrolyte volume.

In another aspect of the method, placing an electrolyte solution comprises an electrolyte and a second redox carrier between the anode and the cathode comprises adding the electrolyte to the well.

In another aspect of the method, adding the electrolyte solution to the well comprises adding the electrolyte to the well as a solution.

In another aspect of the method, the solution is allowed to dry.

In another aspect of the method, adding the electrolyte solution to the well comprises forming a hydrogel in the well.

In another aspect of the method, the hydrogel is selected from the group consisting of cross-linked acrylates, methyl methacrylates, methacrylates, hydryxalkyl acrylates, hydroxyalkyl(meth)acrylates, acrylamides, silicone hydrogels, gelatin, cellulose nitrate, cellulose, agar, and agarose and methods thereof.

In another aspect of the method, forming a well around the anode and the cathode comprises placing a laminating material comprises a hole onto the substrate such that the hole is disposed over the anode and cathode.

In another aspect of the method, covering the well with the membrane comprises depositing a plasticized PVC membrane material dissolved in a volatile solvent over the well.

In another aspect the method further comprises first covering the well with a layer of microporous cellulose acetate and then depositing the PVC membrane material onto the microporous cellulose acetate.

In yet another embodiment of the invention, a method of preparing an amperometric sensor is provided. The method comprises selecting a guanidinium salt, preparing a solvent containing the guanidinium salt, imbibing a first redox-active species impermeant membrane with the solvent, forming a reversible anode and an inert cathode, applying an electrolyte solution comprises an electrolyte and a second redox carrier over the anode and the cathode, allowing the solution to evaporate and covering both electrodes with the redox-active species impermeant membrane, such that the membrane prevents communication between the electrolyte and an ambient environment except through the membrane.

In another aspect of the method, the electrolyte layer is a hydrogel.

In another aspect of the method, the hydrogel is selected from the group consisting of gelatin, cellulose nitrate, cellulose, agar and agarose.

In another aspect of the method, the hydrogel is selected from the group consisting of cross-linked acrylates, methyl methacrylates, methacrylates, hydroxyalkyl acrylates, hydroxyalkyl(meth)acrylates and acrylamides.

In yet another embodiment of the invention, a method of measuring a redox-active species in a liquid sample is provided. The method comprises relaying a redox potential from the sample through a redox relay membrane, relaying the redox potential through an electrolyte solution, the electrolyte solution comprises an electrolyte and a second redox carrier and applying an electrical potential to an electrode.

In another aspect the method further comprises removing an ionic product of an electrode reaction from the electrolyte solution using a guanidinium salt.

In another aspect of the method, the redox active species comprise chlorine, hypochlorous acid, hypochlorite ion, other chlorine oxyacids and their conjugate bases, other halogens, oxyhaloacids and their conjugate bases, monochloroamine, dichloramine, trichloroamine, other chloroamines derived from organic amines, other haloamine species, hydrogen peroxide, hydroperoxyl anion, peroxide dianion, sulfur dioxide, bisulfite anion, sulfite dianion, thiosufate dianion, hydrogen sulfide, hydrosulfide anion, sulfide dianion, mercaptans and their conjugate bases, or organic disulfides.

In another aspect of the method, the first redox carrier and the second redox carrier are selected such that the first redox carrier is oxidized and the second redox carrier is oxidized to permit measurement of an oxidizing species.

In another aspect of the method, the first redox carrier and the second redox carrier are selected such that the first redox carrier is reduced and the second redox carrier is reduced to permit measurement of a reducing species.

In yet another embodiment of the invention, a sensor for aqueous chlorine and chlorine-ammonia mixtures is provided that comprises a supported liquid membrane consisting of a microporous polycarbonate support membrane containing 2-methylnaphthoquinone dissolved in ortho-nitrophenyl octyl ether at a concentration between 0.1 and 5% (wt/wt), in contact with an agar (0.1-2.0 wt %) hydrogel electrolyte containing sodium meta-vanadate (5-50 millimolar) and potassium chloride (0.1-1.0 molar), in separate contact with a silver/silver chloride anode and a gold cathode.

### BRIEF DESCRIPTION OF THE DRAWINGS

FIG. 1 is a redox carrier membrane amperometric sensor for an oxidizing analyte in the external solution in accordance with an embodiment of the invention.

FIGS. 2A and 2B show the sensor of an embodiment of the invention's response to hypochlorite (FIG. 2A) and monochloroamine (FIG. 2B). [pH 6.0, 50 ppm bicarbonate buffer, 25° C., concentrations in ppm].

### DETAILED DESCRIPTION

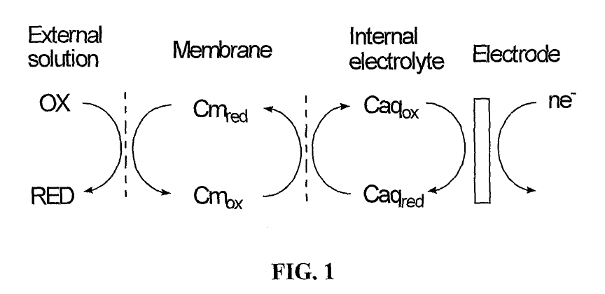

The strategy for construction of a redox carrier membrane amperometric sensor is illustrated in FIG. 1 for an oxidizing analyte in the external solution. Detection of membrane-impermeant oxidizing or reducing species is achieved via a redox relay in which the species of interest oxidizes or reduces a redox carrier in the membrane, the oxidized or reduced carrier diffuses to the inner interface of the sensor where it in turn oxidizes or reduces an aqueous redox carrier in the internal electrolyte. The discharge of this second carrier at a polarized electrode then generates a current in proportion to the concentration of the initial oxidant or reductant concentration in the sample.

In FIG. 1, OX is the oxidizing species to be detected by the sensor, for example, but not limited to hypochlorite or monochloroamine. This species is present in the external solution at some concentration. At the membrane-external solution interface, the species OX oxidizes the redox carrier in the membrane (Cm) from its reduced form (Cm_{red}) to its oxidized form (Cmₒₓ). As a result the species OX is itself reduced to a reduced form RED. The oxidized membrane carrier (Cmₒₓ) diffuses down its concentration gradient towards the internal electrolyte solution. At the internal solution-membrane interface, the oxidized membrane carrier oxidizes a redox carrier in the aqueous internal electrolyte from its reduced form (Caq_{red}) to its oxidized form (Caqₒₓ,). At the same time this reaction regenerates the reduced form of the membrane redox carrier (Cm_{red}). The oxidized aqueous redox carrier in the internal electrolyte then diffuses down its concentration to the electrode where it is reduced. This consumes electrons from the external circuit which can be measured as the analytical signal. The reaction regenerates the reduced form of the aqueous redox carrier.

It is obvious that this strategy is potentially reversible and would equally apply to the detection of the species RED in the external solution. In this case RED would reduce Cmₒₓ to Cn_{red} which in turn would reduce Caqₒₓ to Caq_{red} that would then be oxidized at the electrode to produce electrons in the external circuit.

In either the oxidizing or reducing form of the sensor, a number of conditions must apply to produce an effective sensor. The principal driving force for the sensor is the potential of the electrode, either cathodic or anodic, relative to a reference and/or counter electrode within the internal electrolyte. The applied potential of the electrode must be chosen to provide a spontaneous conversion between Caqₒₓ and Caq_{red} such that the required carrier species is discharged at the electrode. This will create the concentration gradient to move the aqueous carrier from the membrane interface to the electrode. Furthermore, at the internal electrolyte/membrane interface the redox reaction between the membrane redox carrier and the aqueous redox carrier must be spontaneous towards the required products of the reaction (Caqₒₓ+Cm_{red} for a sensor of OX; Caq_{red}+Cmₒₓ for a sensor for RED). This in turn will create the required concentration gradient in the membrane redox carrier across the membrane. Finally, at the external solution/membrane interface the redox reaction between the membrane redox carrier and the detected species in the external solution is spontaneous towards the required products of the reaction (Cmₒₓ+RED for a sensor of OX; Cm_{red}+OX for a sensor of RED).

In addition to the thermodynamic considerations, there are kinetic considerations that will govern the utility of a sensor designed according to FIG. 1. The membrane redox carrier should diffuse across the membrane at a sufficient rate to produce a detectible current. The diffusion through the membrane will depend on the nature of the carrier, the thickness of the membrane and the viscosity of the membrane. Diffusion of the aqueous redox carrier within the internal aqueous electrolyte should also be acceptably fast. This too is determined by the nature of the carrier, the thickness of the aqueous internal electrolyte layer, and the viscosity of the electrolyte. At the same time, the interfacial reaction rates at the external solution/membrane interface and the internal solution/membrane interface should also be sufficiently rapid to provide a detectible current.

Finally, all real redox systems will involve counter ions and other reactants and products of the redox reactions. These additional species play a role in the thermodynamic and kinetic factors noted above. For example, the membrane will typically have a low dielectric constant that will not support charge separation. Thus the oxidation of Cm_{red} to Cmₒₓ will typically be accompanied by the transfer of a counter cation to the membrane phase for each electron transferred from OX to Cm. Similar transfers also apply in a sensor for RED. Some provision should be made to accommodate the counterion within the membrane phase, either, for example, but not limited to, through association with the membrane redox carrier itself or with a second carrier specifically for the counterion [for example as reported by Grimaldi, J. J.; Lehn, J.-M. J. Am. Chem. Soc. 1979, 101, 1333-1334]. Similar considerations apply to all other redox couples in the system. In a global sense, the overall reaction from the external solution to the discharge at the electrode involves the transfer of a counterion from the external solution to the internal electrolyte or in the other direction to provide for charge neutralization of the electron(s) transferred from OX (or to RED) to (or from) the polarized electrode. In either case, the continued stable function of the sensor requires these additional fluxes to be balanced using an appropriate reaction at the internal counter electrode, or via a mechanism to equilibrate composition such as providing an additional carrier in the membrane [for example, but not to be limiting, as in U.S. Pat. No. 6,391,174]

These general considerations could be applied to the detection of a number of different oxidizing and reducing species. For example, OX could be chlorine, hypochlorous acid, hypochlorite ion, other chlorine oxyacids and their conjugate bases, other halogens, oxyhaloacids and their conjugate bases, monochloroamine, dichloramine, trichloroamine, other chloroamines derived from organic amines, other haloamine species, hydrogen peroxide, hydroperoxyl anion, peroxide dianion, etc. Examples for RED include sulfur dioxide, bisulfite anion, sulfite dianion, thiosufate dianion, hydrogen sulfide, hydrosulfide anion, sulfide dianion, mercaptans and their conjugate bases, organic disulfides, etc. These lists are not exhaustive as many additional species will fulfill the thermodynamic constraints upon the species OX and RED as described above, as would be known to one skilled in the art.

### EXAMPLE 1

As a practical implementation of the general strategy we considered a sensor for aqueous chlorine and aqueous chlorine/ammonia mixtures—a sensor for the total of oxidizing chlorine species in an aqueous solution. All these chlorine species (free chlorine, hypochlorous acid, hypochlorite, mono-, di- and tri-chloroamines) are strong oxidizing agents. For example the standard reduction potential for hypochlorous acid is +1.715 V vs NHE [Pourbaix, op cit.] while the standard reduction potential of monochloroamine is +1.527 V vs NHE [Soulard et al op cit.]]. These species are therefore capable of oxidizing hydroquinones (H₂Q) to quinones (Q) (standard reduction potential=+0.44V vs NHE [Clark, W. M. Oxidation-Reduction Potentials of Organic Systems, Williams and Wilkins, 1960]). Thus the reaction:

H₂Q+HOCl→Q+HCl+H₂O

fulfills the requirement of spontaneity for the reaction at the external solution/membrane interface.

At the membrane/internal electrolyte interface, a quinone is capable of oxidizing a variety of inorganic species such as ferrocyanide (standard reduction potential for ferricyanide =+0.36 V [Clark, op cit.]) or trivalent vanadium (reduction potential for H₂VO₄⁻˜0−+0.2V near pH 7 [Pourbaix, op cit. section 9.1]). Thus a reaction such as:

2Fe(CN)₆⁴⁻+Q→H₂Q+2Fe(CN)₆³⁻+2H⁺

or

HV₂O₅⁻+Q+3H₂O→H₂VO₄⁻+H₂Q(pH>4)

fulfills the requirement of spontaneity for the reaction at the internal electrolyte/membrane interface. The product ferricyanide or ortho-vanadate ions can be discharged at an electrode potential more negative than −0.3 V relative to Ag/AgCl. This fulfills all the thermodynamic requirements for a sensor for the oxidizing chlorine species noted above.

The kinetic requirements for the sensor require a sufficiently rapid diffusion of the membrane redox carriers Q and H₂Q. This can be achieved in solvent-polymer membranes with a large solvent fraction, or in supported liquid membrane such as those formed by imbibing a non-polar solvent into the pores of a microporous membrane. The diffusion flux will be enhanced as the thickness of the membrane decreases. The diffusion will be enhanced by quinones of relatively low molecular weight such as menadione (Vitamin K).

The overall process for the proposed embodiment of the redox relay carrier membrane system for a chlorine species sensor involves the transfer of two electrons from the external solution to the internal electrolyte solution with the concomitant transfer of two protons from the internal electrolyte to the external solution. The internal electrolyte solution will thus become basic as the sensor functions. This is similar to the build-up of hydroxide ions in a conventional Clark cell for dissolved oxygen and could be equilibrated through the use of an additional ion exchange carrier as previously disclosed [for example as in U.S. Pat. No. 6,391,174]. In this approach external chloride would be exchanged for the internal hydroxide, and would ultimately be incorporated in a silver chloride counter electrode to result in an overall neutral process.

### EXAMPLE 2

A functioning sensor was constructed on a printed circuit board (PCB) on which a gold cathode of 1 mm diameter was formed within a concentric silver-silver chloride anode of 6 mm diameter. The PCB was cleaned with ethanol and a layer of two sided tape (3M) with a 6 mm diameter hole punched was placed over the anode. The backing of the two sided tape provided a shallow reservoir into which a warm solution of agar in 0.1M potassium chloride containing 5×10⁻³ M sodium meta-vanadate was placed. The excess agar was screened to flush with the tape backing, allowed to cool, and the backing was removed to produce a thin layer of the agar hydrogel covering the anode and cathode completely.

The membrane was formed in a 13 mm diameter Nucleopore™ membrane filter with a nominal pore diameter of 0.4 microns. A solution of menadione (2-methylnaphthoquinone; 12 mg) in ortho-nitrophenyl octyl ether (0.1 ml) was imbibed in the pores of the filter on a glass plate, allowed to soak for 20 minutes, and the excess solution was removed onto KimWipe™ tissues. The membrane was placed above the agar layer on the PCB and secured in placed by pressing the edges of the membrane to the two-sided tape layer on the PCB. The PCB was mounted in a connector that supplied a potential of −0.5V to the cathode relative to the anode, and the current of the sensor was monitored.

### EXAMPLE 3

The electrode was placed in a 50 ppm bicarbonate buffer at pH 6. The electrode showed no response to dissolved oxygen levels in this solution, but gave positive current response to both 10 ppm hypochlorite solution and 10 ppm monochloroamine solution in the same buffer at pH 6.0.

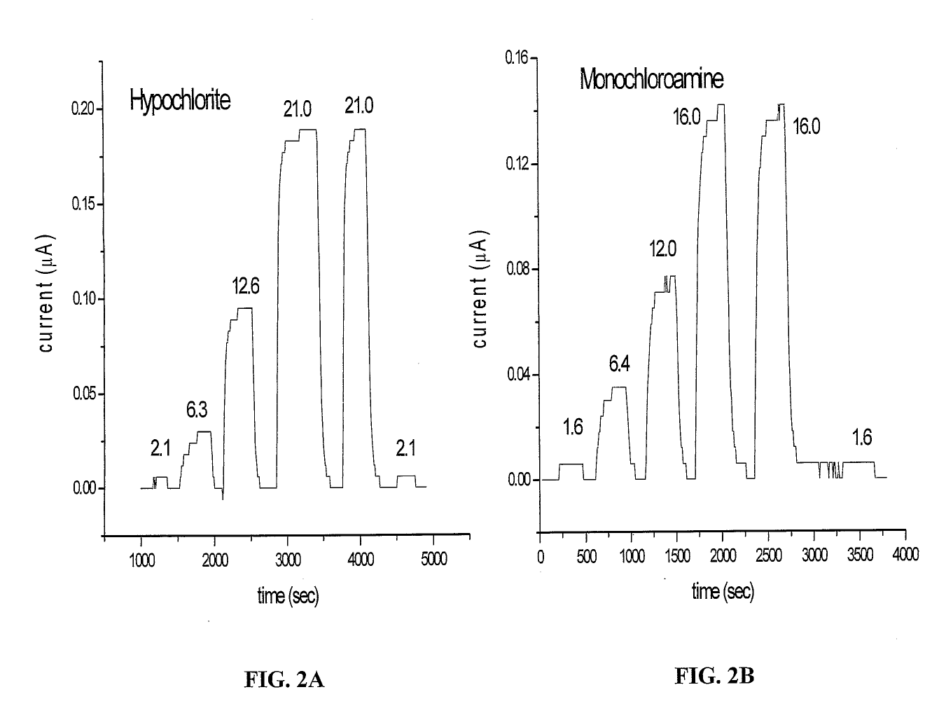

FIGS. 2A and 2B show the response of the sensor to an increasing series of concentrations of hypochlorite (FIG. 2A) and monochloroamine (FIG. 2B). In both cases the calibration was linear with slopes that were equal within experimental error.

It should be recognized that the illustrated embodiments are only particular examples of the inventions and should not be taken as a limitation on the scope of the inventions. As would be known to one skilled in the art, the invention can take many forms. For example, other hydrogels may include but are not restricted to cross-linked acrylates, methacrylates, hydroxyalkyl(meth)acrylates and acrylamides, silicone hydrogels, gelatin, cellulose nitrate, cellulose, and agarose. Similarly, redox carriers other than quinones can be employed, and would be readily determined from the foregoing description by one skilled in the art. Also, other membrane types would be applicable as well. For example, but not to be limiting, supported membranes based on microporous Teflon and plasticized membranes such as plasticized poly vinylchloride, silicone rubber, and polyurethanes can also be employed. Further the PCB or printed circuit board mentioned in the above example can take many forms and methods of construction. For example but not to be limiting the substrate can be a fiberglass material, Teflon™, polyimide or other commercially available materials for the construction of printed circuit boards. There are also ceramic substrates available. Some of these systems may be on flexible substrate materials. The process that is used to deposit the sensor electrodes also varies. The most basic printed circuit board uses a copper etching process followed by electroplating or immersion plating techniques to achieve the desired gold and silver/silver chloride electrodes. It is also possible to use metallic pastes which are “screened” onto the substrate and subsequently cured by heating.

1. A redox relay membrane system for use with an electrode to transfer a redox potential from a redox-active species to an electrode by redox reactions, said redox relay membrane system comprising:
a redox relay membrane comprising a first redox carrier and a membrane, said membrane being impermeant to redox-active species; and
an internal electrolyte solution comprising an electrolyte and a second redox carrier.

2-117. (canceled)
